(19) United States
(12) Patent Application Publication
(10) Pub. No.: US 2012/0001589 A1
(43) Pub. Date: Jan. 5, 2012

(54) Bidirectional wireless charging/discharging device

(76) Inventor: Ming-Hsiang Yeh, Taipei City (TW)

(21) Appl. No.: 13/067,711

(22) Filed: Jun. 22, 2011

(30) Foreign Application Priority Data
Jun. 30, 2010 (TW) 099212466

(51) Int. Cl. H02J 7/00

(52) U.S. Cl. 320/108

(57) ABSTRACT

A bidirectional wireless charging/discharging device includes: a first receiver/transmitter device and a second receiver/transmitter device. The first receiver/transmitter device includes a first power storage/supply device that supplies and converts a first electrical power into a first frequency modulation signal. A first resonant circuit device, when set in an activated state, receives and converts the first frequency modulation signal into first resonance energy. The second receiver/transmitter device is arranged to correspond to the first receiver/transmitter device. The second receiver/transmitter device includes a second resonant circuit device, which when set in a deactivated state, receives and converts the first resonance energy into a third frequency modulation signal. A second power storage/supply device receives the third frequency modulation signal, and converts the third frequency modulation signal into a third electrical power for storage. When the first resonant circuit device is set in a deactivated state and the second resonant circuit device is in an activated state, the second power storage/supply device supplies and converts a second electrical power into a second frequency modulation signal, which is received and converted by the second resonant circuit device into second resonance energy. The first resonant circuit device receives and converts the second resonance energy into a fourth frequency modulation signal. The first power storage/supply device receives and converts the fourth frequency modulation signal into a fourth electrical power for storage. As such, a function of bidirectional wireless charging and discharging is realized.

### FIELD OF THE INVENTION

The present invention relates generally to a charging/discharging device, and in particular to a bidirectional wireless charging/discharging device that carries out bidirectional charging and discharging operations for wireless devices.

### BACKGROUND OF THE INVENTION

Recently, with the advancing of technology, the demand for electronic devices by general consumers is increasingly upgraded, especially for consumer electronic products. Electronic devices, which were bulky in size, such as optic disk players, household telephones, and desk-top computers, are being changed to compact and portable electronic products of high performance, such as multimedia player (for example MPEG Audio Layer-3, MP3), mobile phones, and notebook computers, all leading to a more efficient life for human beings.

Most of such portable electronic products, including the multimedia players and mobile phones, are powered by rechargeable batteries or cells, such as nickel hydride battery and lithium battery. The rechargeable battery is re-chargeable through a charging device or charger, which is composed of a charging seat and an electrical connector. The charging seat is connected to the electrical connector through a cable and forms a charging chamber in which the rechargeable battery is positioned, while the electrical connector is set in connection with a power socket, such as a wall outlet, to supply a required voltage or current to charge the rechargeable battery. The portable electronic products are powered by an adaptor or a rechargeable battery, and the charging device or the adaptor requires a wired connection for supplying electrical power to the rechargeable battery. This imposes a constraint to the range of use.

In view of the drawback, the present invention aims to provide a device that is capable of carrying out bidirectional charging/discharging functions, in a wireless manner, for electronic products, so that the use range is not constrained.

### SUMMARY OF THE INVENTION

An objective of the present invention is to provide a bidirectional wireless charging/discharging device, wherein a resonant circuit device, when set in an activated state, transmits resonance energy, while a counterpart resonant circuit device, when set in a deactivated state, receives the resonance energy, so as to realize the function of bidirectional wireless charging for electronic devices.

To achieve the above objective, the present invention provides a bidirectional wireless charging/discharging device, which comprises: a first receiver/transmitter device and a second receiver/transmitter device. The first receiver/transmitter device comprises: a first power storage/supply device and a first resonant circuit device. The first power storage/supply device supplies a first electrical power and converts the first electrical power into a first frequency modulation signal, and receives a fourth frequency modulation signal and converts the fourth frequency modulation signal into a fourth electrical power for storage. The first resonant circuit device is in electrical connection with the first power storage/supply device. The first resonant circuit device, when set in an activated state, receives and converts the first frequency modulation signal into first resonance energy, and, when set in a deactivated state, receives and converts second resonance energy into the fourth frequency modulation signal.

The second receiver/transmitter device is arranged to correspond to the first receiver/transmitter device. The second receiver/transmitter device comprises: a second power storage/supply device and a second resonant circuit device. The second resonant circuit device is arranged to correspond to the first resonant circuit device. The second resonant circuit device, when set in a deactivated state, receives and converts the first resonance energy into a third frequency modulation signal, and, when set in an activated state, receives and converts a second frequency modulation signal into the second resonance energy. The second power storage/supply device is in electrical connection with the second resonant circuit device. The second power storage/supply device receives the third frequency modulation signal and converts the third frequency modulation signal into a third electrical power for storage, and supplies a second electrical power and converts the second electrical power into the second frequency modulation signal.

### BRIEF DESCRIPTION OF THE DRAWINGS

The present invention will be apparent to those skilled in the art by reading the following description of a preferred embodiment thereof with reference to the drawings, in which:

FIG. 1 shows a schematic block diagram of a bidirectional wireless charging/discharging device according to a preferred embodiment of the present invention; and

FIG. 2 shows a schematic circuit diagram illustrating correspondence between a first resonant circuit device and a second resonant circuit device according to a preferred embodiment of the present invention.

### DETAILED DESCRIPTION OF THE PREFERRED EMBODIMENT

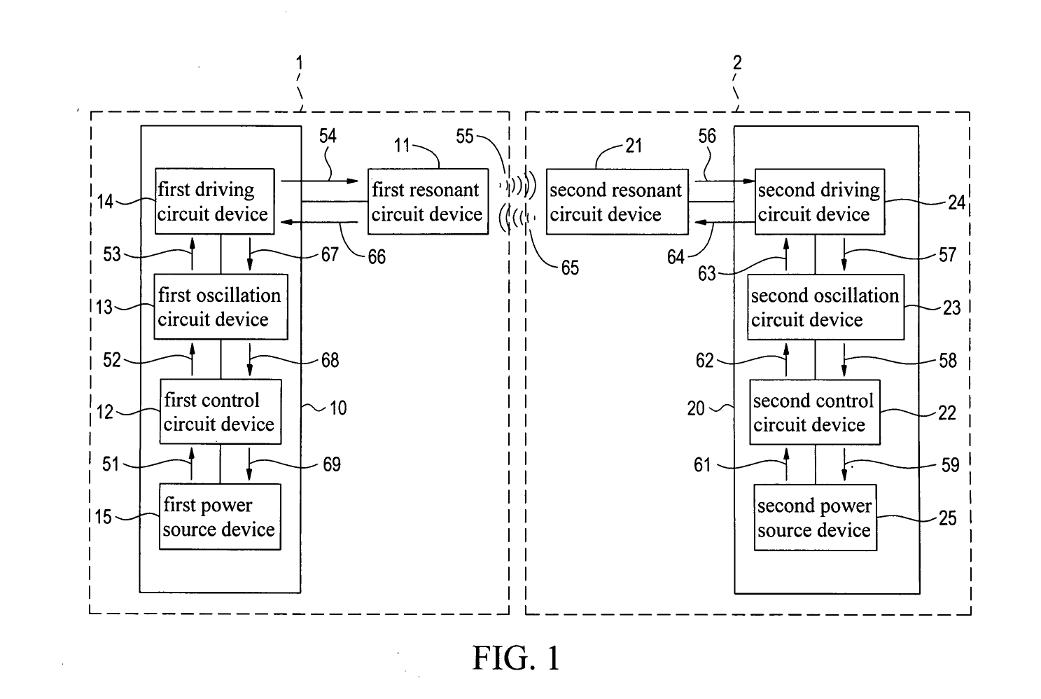

With reference to the drawings and in particular to FIG. 1, which shows a schematic block diagram of a bidirectional wireless charging/discharging device according to a preferred embodiment of the present invention, the bidirectional wireless charging/discharging device of the present invention comprises: a first receiver/transmitter device 1 and a second receiver/transmitter device 2. The first receiver/transmitter device 1 comprises: a first power storage/supply device 10 and a first resonant circuit device 11. The first power storage/supply device 10 supplies a first electrical power 51 and converts the first electrical power 51 into a first frequency modulation signal 54. In a preferred embodiment of the present invention, the first power storage/supply device 10 further comprises: a first control circuit device 12, a first oscillation circuit device 13, a first driving circuit device 14. Firstly, the first power storage/supply device 10 supplies the first electrical power 51 from a first power source device 15 (such as a rechargeable battery) thereof and the first control circuit device 12 converts the first electrical power 51 into a first DC (Direct Current) signal 52. The first oscillation circuit device 13 is in electrical connection with the first control circuit device 12 and the first oscillation circuit device 13 receives and converts the first DC signal 52 into a first AC (Alternating Current) signal 53. The first driving circuit device 14 is in electrical connection with the first oscillation circuit device 13 and the first driving circuit device 13 receives and converts the first AC signal 53 into the first frequency modulation signal 54.

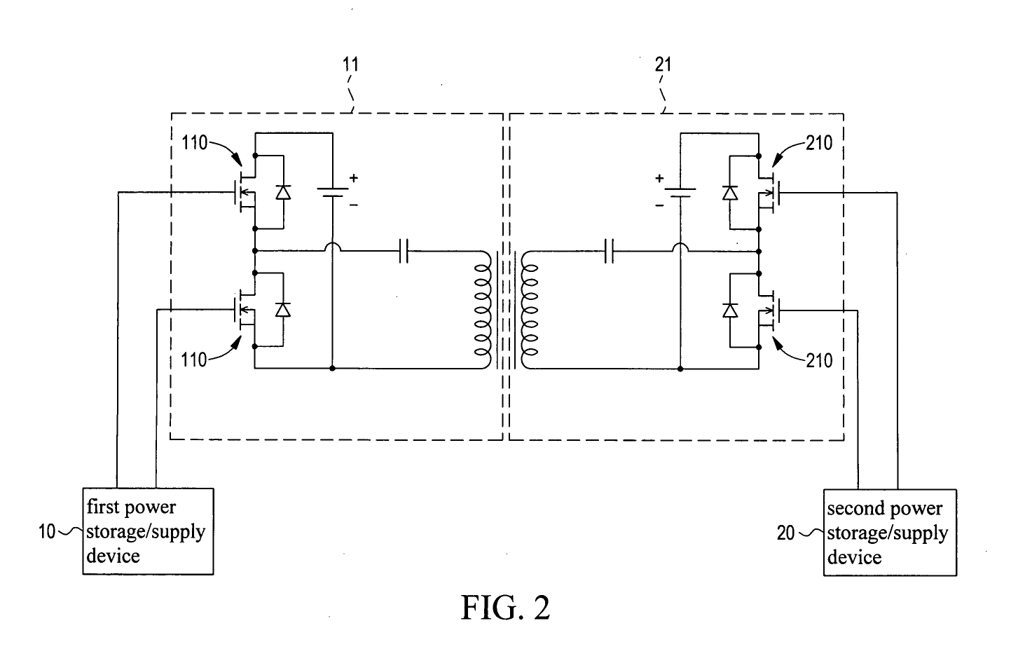

Referring to FIG. 2, which shows a schematic circuit diagram illustrating correspondence between the first resonant circuit device and a second resonant circuit device according to a preferred embodiment of the present invention, the first resonant circuit device 11 is in electrical connection with the first power storage/supply device 10. In a preferred embodiment of the present invention, the first resonant circuit device 11 comprises a half-bridge power circuit composed of at least two electrically-connected metal oxide semiconductor field effect transistors (MOSFETs) 110. When the first resonant circuit device 11 is in an activated state, in which at least one of the MOSFETs 110 is in an operation condition, and the first resonant circuit device 11 is in a transmitting condition. The first resonant circuit device 11 receives and converts the first frequency modulation signal 54 into first resonance energy 55.

The second receiver/transmitter device 2 is arranged to correspond to the first receiver/transmitter device 1. The second receiver/transmitter device 2 comprises: a second resonant circuit device 21 and a second power storage/supply device 20. The second resonant circuit device 21 is arranged to correspond to the first resonant circuit device 11. In a preferred embodiment according to the present invention, the second resonant circuit device 21 comprises a half-bridge power circuit that is composed of electrically-connected MOSFETs 210. Under the condition described above, the second resonant circuit device 21 is in a deactivated state, in which all the MOSFETs 210 are not in an operation condition, and the second resonant circuit device 21 is in a receiving condition. The second resonant circuit device 21 receives and converts the first resonance energy 55 into a third frequency modulation signal 56. The second power storage/supply device 20 is in electrical connection with the second resonant circuit device 21, whereby the second power storage/supply device 20 receives the third frequency modulation signal 56 and converts the third frequency modulation signal 56 into a third electrical power 59 for storage.

In a preferred embodiment of the present invention, the second power storage/supply device 20 comprises: a second driving circuit device 24, a second oscillation circuit device 23, and a second control circuit device 22. The second driving circuit device 24 is in electrical connection with the second resonant circuit device 21 and the second driving circuit device 24 receives and converts the third frequency modulation signal 56 into a third AC signal 57. The second oscillation circuit device 23 is in electrical connection with the second driving circuit device 24 and the second oscillation circuit device 23 receives and converts the third AC signal 57 into a third DC signal 58. The second control circuit device 22 is in electrical connection with the second oscillation circuit device 23 and the second control circuit device 22 receives and converts the third DC signal 58 into the third electrical power 59 to be stored in a second power source device 25 (such as a rechargeable battery).

Certainly, the second resonant circuit device 21 can be set in an activated state, in which at least one of the MOSFETs 210 is in an operation condition, and the second resonant circuit device 21 is now in a transmitting condition; and the first resonant circuit device 11 is correspondingly set in a deactivated state, in which all the MOSFETs 110 are not in operation condition, and the first resonant circuit device 11 is in a receiving condition. Under this condition, the second power storage/supply device 20 supplies a second electrical power 61 from the second power source device 25 (such as a rechargeable battery) thereof and the second control circuit device 22 converts the second electrical power 61 into a second DC signal 62. The second oscillation circuit device 23 receives and converts the second DC signal 62 into a second AC signal 63. The second driving circuit device 24 receives and converts the second AC signal 63 into a second frequency modulation signal 64. And, under this condition, the second resonant circuit device 21 is in the transmitting condition, and the second resonant circuit device 21 receives and converts the second frequency modulation signal 64 into second resonance energy 65. The first resonant circuit device 11 is in the receiving condition and the first resonant circuit device 11 receives and converts the second resonance energy 65 into a fourth frequency modulation signal 66. The first driving circuit device 14 receives and converts the fourth frequency modulation signal 66 into a fourth AC signal 67. The first oscillation circuit device 13 receives and converts the fourth AC signal 67 into a fourth DC signal 68. The first control circuit device 12 receives and converts the fourth DC signal 68 into a fourth electrical power 69 to be stored in the first power source device 15. As such, the present invention realizes a function of bidirectional wireless charging for electronic devices.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A bidirectional wireless charging/discharging device, comprising:
a first receiver/transmitter device, which comprises:
a first power storage/supply device, which supplies a first electrical power and converts the first electrical power into a first frequency modulation signal, and also receives a fourth frequency modulation signal and converts the fourth frequency modulation signal into a fourth electrical power for storage, and
a first resonant circuit device, which is in electrical connection with the first power storage/supply device, whereby the first resonant circuit device, when set in an activated state, receives and converts the first frequency modulation signal into first resonance energy, and, when set in a deactivated state, receives and converts second resonance energy into the fourth frequency modulation signal; and
a second receiver/transmitter device, which is arranged to correspond to the first receiver/transmitter device, the second receiver/transmitter device comprising:
a second resonant circuit device, which is arranged to correspond to the first resonant circuit device, whereby the second resonant circuit device, when set in a deactivated state, receives and converts the first resonance energy into a third frequency modulation signal, and, when set in an activated state, receives and converts a second frequency modulation signal into the second resonance energy, and
a second power storage/supply device, which is in electrical connection with the second resonant circuit device, the second power storage/supply device receiving the third frequency modulation signal and converting the third frequency modulation signal into a third electrical power for storage, and supplying a second electrical power and converting the second electrical power into the second frequency modulation signal.

2. The bidirectional wireless charging/discharging device as claimed in claim 1, wherein the first power storage/supply device comprises:
a first control circuit device, which converts the first electrical power into a first DC signal, and receives and converts a fourth DC signal into the fourth electrical power for storage;
a first oscillation circuit device, which is in electrical connection with the first control circuit device, the first oscillation circuit device receiving and converting the first DC signal into a first AC signal, and receiving and converting a fourth AC signal into the fourth DC signal; and
a first driving circuit device, which is in electrical connection with the first oscillation circuit device, the first driving circuit device receiving and converting the first AC signal into the first frequency modulation signal, and receiving and converting the fourth frequency modulation signal into the fourth AC signal.

3. The bidirectional wireless charging/discharging device as claimed in claim 1, wherein the first resonant circuit device comprises at least two metal oxide semiconductor field effect transistors.

4. The bidirectional wireless charging/discharging device as claimed in claim 3, wherein the activated state comprises at least one of the metal oxide semiconductor field effect transistors being set in an operation condition.

5. The bidirectional wireless charging/discharging device as claimed in claim 3, wherein the deactivated state comprises the metal oxide semiconductor field effect transistors being all not in an operation condition.

6. The bidirectional wireless charging/discharging device as claimed in claim 1, wherein the second power storage/supply device comprises:
a second driving circuit device, which is in electrical connection with the second resonant circuit device, the second driving circuit device receiving and converting the third frequency modulation signal into a third AC signal, and receiving and converting a second AC signal into the second frequency modulation signal;
a second oscillation circuit device, which is in electrical connection with the second driving circuit device, the second oscillation circuit device receiving and converting the third AC signal into a third DC signal, and receiving and converting a second DC signal into the second AC signal; and
a second control circuit device, which is in electrical connection with the second oscillation circuit device, the second control circuit device receiving and converting the third DC signal into the third electrical power for storage, and receiving and converting the second electrical power into the second DC signal.

7. The bidirectional wireless charging/discharging device as claimed in claim 1, wherein the second resonant circuit device comprises at least two metal oxide semiconductor field effect transistors.

8. The bidirectional wireless charging/discharging device as claimed in claim 7, wherein the activated state comprises at least one of the metal oxide semiconductor field effect transistors being set in an operation condition

9. The bidirectional wireless charging/discharging device as claimed in claim 7, wherein the deactivated state comprises the metal oxide semiconductor field effect transistors being all not in an operation condition.
